(19) United States
(12) Patent Application Publication
(10) Pub. No.: US 2014/0342168 A1
(43) Pub. Date: Nov. 20, 2014

(54) ARTICLE FOR HIGH TEMPERATURE SERVICE

(71) Applicant: General Electric Company, Schenectady, NY (US)

(72) Inventor: Don Mark Lipkin, Niskayuna, NY (US)

(73) Assignee: General Electric Company, Schenectady, NY (US)

(21) Appl. No.: 13/896,612

(22) Filed: May 17, 2013

(51) Int. Cl. C09D 1/00

(52) U.S. Cl. CPC C09D 1/00
USPC 428/448; 428/446; 106/286.1; 106/286.2

(57) ABSTRACT

Articles for use at high temperatures, for example as gas turbine engine components, are described. The article includes a substrate and a coating disposed over the substrate. The coating includes a silicate phase that has a composition in accordance with the formula (A₍₁₋ₓ₎Dₓ)₂Si₂O₇, where x is a number at least 0.03 and up to 1; wherein A includes yttrium and D includes a Group 13 element, such as indium, gallium, and/or aluminum. Various combinations of other coatings may be included with the silicate-containing coating to enhance protection.

### BACKGROUND

This invention relates to high-temperature machine components. More particularly, this invention relates to coating systems for protecting machine components from exposure to high-temperature environments.

High-temperature materials, such as, for example, ceramics, metallic alloys, and intermetallics, offer attractive properties for use in structures designed for service at high temperatures in such applications as gas turbine engines, heat exchangers, and internal combustion engines. However, the environments characteristic of these applications often contain reactive species, such as water vapor, which at high temperatures may cause significant degradation of the material structure. For example, water vapor has been shown to cause significant surface recession and mass loss in silicon-bearing materials. The water vapor reacts with the structural material at high temperatures to form volatile silicon-containing species, often resulting in unacceptably high recession rates.

Environmental bather coatings (EBC's) are applied to silicon-bearing materials and other material susceptible to attack by reactive species, such as high temperature water vapor; EBC's provide protection by prohibiting contact between the environment and the surface of the material being protected. EBC's applied to silicon-bearing materials, for example, are designed to be relatively stable chemically in high-temperature, water vapor-containing environments. One illustrative EBC system, as described in U.S. Pat. No. 6,410,148, comprises a silicon or silica bond layer (also referred to herein as a “bondcoat”) applied to a silicon-bearing substrate; an intermediate layer comprising mullite or a mixture of mullite and alkaline earth aluminosilicate deposited over the bond layer; and a top layer comprising an alkaline earth aluminosilicate deposited over the intermediate layer. In another example, U.S. Pat. No. 6,296,941, the top layer includes yttrium silicate.

The above coating systems can provide suitable protection for articles in demanding environments, but opportunities for improvement exist. For instance, yttrium silicate materials, such as yttrium disilicate and yttrium monosilicate, may be prone to cracking during high-temperature service.

Therefore, there remains a need in the art for environmental barrier coatings with improved durability at high temperatures. There is also a need for machine components employing these coating systems to enhance high-temperature service capability.

### BRIEF DESCRIPTION

Embodiments of the present invention are provided to meet these and other needs. One embodiment is an article. The article comprises a substrate and a coating disposed over the substrate. The coating comprises a silicate phase that has a composition in accordance with the formula (A₍₁₋ₓ₎Dₓ)₂Si₂O₇, where x is a number at least 0.03 and up to 1; wherein A comprises yttrium and D comprises a Group 13 (also known as Group IIIB) element.

Another embodiment is an article. The article comprises a substrate comprising a silicon-bearing ceramic material; a bondcoat comprising silicon disposed over the substrate; and a coating disposed over the bondcoat, wherein the coating comprises a silicate phase, the silicate phase having a composition in accordance with the formula (A₍₁₋ₓ₎Dₓ)₂Si₂O₇, where x is a number at least 0.13 and up to 1; wherein A comprises yttrium and D comprises indium.

Another embodiment is an article. The article comprises a substrate comprising a silicon-bearing ceramic material; a bondcoat comprising silicon disposed over the substrate; and a coating disposed over the bondcoat, wherein the coating comprises a silicate phase, the silicate phase having a composition in accordance with the formula (A₍₁₋ₓ₎Dₓ)₂Si₂O₇, where x is a number at least 0.05 and less than 1, and wherein A comprises yttrium and D comprises gallium.

Another embodiment is an article. The article comprises a substrate comprising a silicon-bearing ceramic material; a bondcoat comprising silicon disposed over the substrate; and a coating disposed over the bondcoat, wherein the coating comprises a silicate phase, the silicate phase having a composition in accordance with the formula (A₍₁₋ₓ₎Dₓ)₂Si₂O₇, where x is a number at least 0.03 and up to 0.06, and wherein A comprises yttrium and D comprises aluminum.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1, 2, and 3 respectively show a schematic cross-sectional view of an illustrative embodiment of the invention.

### DETAILED DESCRIPTION

According to one embodiment of the present invention, an article for use at high temperature comprises a substrate and a coating disposed over the substrate. Examples of such an article include, for example, a component of a gas turbine assembly, such as, but not limited to, a blade, vane, shroud, or combustor component, such as a combustor liner. Because the efficiency of a gas turbine generally increases with the firing temperature, having components capable of operation at increased temperatures may offer benefits leading to enhanced fuel economy and reduced emissions. Moreover, increasing the service life of the EBC system may improve cost-effectiveness by, for example, increasing the intervals between major service events.

The coating may be part of a multilayered EBC system designed to protect the substrate from high-temperature environments. In one embodiment, a bondcoat is disposed between the substrate and the coating, either immediately between or with one or more intervening intermediate layers. The bondcoat typically comprises silicon; examples of bondcoat materials include elemental silicon, silicon oxide, and silicide compounds. The bondcoat acts to inhibit deleterious oxidation reactions from occurring at the substrate/coating interface and to promote adhesion of the EBC system to the substrate.

In a further embodiment, one or more additional layers, such as a topcoat, may be disposed over the coating, either directly adjacent or with one or more intervening intermediate layers. As used herein, the term “topcoat” is not applied to mean an outermost layer of a stack of layers; instead, “topcoat” is applied only to mean a layer that is disposed over the coating mentioned above, and other coatings may be disposed over the topcoat. Furthermore, as noted above, any layer that is described herein as being disposed “over” a given layer may be disposed immediately adjacent to the given layer (that is, in direct physical contact) or may be disposed in contact with one or more intermediate layers situated between the disposed layer and the given layer.

In some embodiments, the function of the topcoat is to provide a recession-resistant barrier to water vapor at high temperatures. Accordingly, any material that provides such a barrier may be suitable for use as a topcoat. In certain embodiments, the topcoat comprises a ceramic material, such as an oxide. Particular examples of suitable ceramic materials include, but are not limited to, an aluminate, a silicate, an aluminosilicate, or some combination including one or more of these; such compounds are known in the art for their effectiveness as recession-resistant coatings. As used herein, the term “silicate” shall be understood to include monosilicates, disilicates, orthosilicates, and other compounds of the silicate family. Examples of compositions that may be included in a topcoat, or as one or more intermediate layers, include aluminates, silicates, and aluminosilicates of alkaline earth elements, yttrium, scandium, or the rare earth elements. Specific examples include barium strontium aluminosilicate, yttrium silicates (such as yttrium monosilicate), and monosilicates of rare earth elements. In alternative embodiments, the function of the topcoat is to provide thermal protection for the substrate. Ceramic thermal barrier coatings (TBC's) are well known in the art for use in high-temperature protection of engineered components. Zirconia, such as yttria-stabilized zirconia, is a prominent example of coatings of this type, and is suitable for use as the topcoat in some embodiments of the present invention. Finally, in some embodiments, one or more layers of additional material, such as a TBC or an abradable material, is disposed over a topcoat of one or more of the recession-resistant coatings described above.

The coating of the present invention comprises a particular silicate phase. The silicate phase has a composition in accordance with the formula:

(A₍₁₋ₓ₎Dₓ)₂Si₂O₇ (formula 1).

The notation of the formula indicates that the atoms represented by D substitute for A in the crystal structure of the silicate phase. In the formula, x is a number at least 0.03 and up to 1. The formula constituent A comprises yttrium (Y), and D comprises a Group 13 (also known as Group IIIB) element, such as, for example, indium, gallium, aluminum, or combinations thereof. In certain embodiments, the majority of D is one or more Group 13 elements, and in particular embodiments, D is substantially all one or more Group 13 elements. In some embodiments, the majority of A is yttrium, and in particular embodiments, A is substantially all yttrium. As used herein, the term “substantially all” means the entirety except for the presence of incidental impurities.

The silicate phase is engineered to be phase stable within a selected temperature range, such as a temperature range of interest to the applications described above. “Phase stable,” as used herein, means that the phase undergoes no solid-state phase transformation over the specified temperature range. Certain silicate phases, such as, but not limited to, yttrium disilicate, though having otherwise attractive properties, are susceptible to undesirable grain growth and cracking over prolonged exposure to temperatures exceeding 1000 degrees Celsius. Further, these undesirable effects may arise from a phase transformation between two monoclinic crystal structures, known in the art as beta (or type-C; comparatively low-temperature phase) and gamma (or type-D; comparatively high-temperature phase) disilicate. Without being bound by theory, the phase transformation may lead to cracking; in the case of coatings, this cracking can lead to loss of coating hermeticity or even spallation of the coating upon thermal cycling. In fact, the problems noted above may be more pronounced in coatings relative to bulk materials, because many coating processes, such as chemical vapor deposition (CVD), physical vapor deposition (PVD), and thermal spray techniques often produce coating structures with grains having crystallographic texture.

To overcome these problems, embodiments of the present invention include compositions that stabilize the beta phase, thereby preventing the undesired beta-to-gamma phase transformation from occurring within a temperature range of interest, which temperature range is generally determined by the maximum temperature for which the component is designed to operate. In one embodiment, the temperature range over which no transformation occurs is up to about 1650 degrees Celsius. It will be appreciated that the definition of the temperature range above does not imply anything about the phase stability of the material outside the stated temperature range; the material may be phase stable outside the stated range, or it may not be, but in any case it is phase stable at temperatures within the stated range.

In one embodiment, the silicate phase is present in the coating at a level of at least about 50% by volume. In certain embodiments, this level is at least about 80% by volume, and in particular embodiments this level is at least about 90% by volume.

In embodiments of the present invention, the addition of species D to the silicate composition serves to stabilize the beta monoclinic phase. In accordance with relationships determined by Felsche and by Ito and Johnson between the ionic radius of a given cation and the stability temperature range of the particular silicate phase, a phase may be stabilized by doping a conventional disilicate of species A with species D, where the trivalent ionic radius of D has a specific relationship to the trivalent ionic radius of A. In the above formula, D is at least one cation (such as one or more of the Group 13 elements) having an ionic radius smaller than the ionic radius of A. These elements may substitute for species A on the six-fold coordination sites in the crystal lattice. When a sufficient amount of species (D) is added to the silicate phase, the mean ionic radius of the sixfold-coordinated cations in the lattice is moved towards values that promote stability of the beta phase over the temperature range of the application.

In one embodiment, D comprises indium. In some such embodiments, the quantity x from formula 1, above, is in the range from about 0.13 to about 1, and in particular embodiments, x is in the range from about 0.15 to about 1. A majority of D (molar basis) may be indium, and in some embodiments D is indium except for incidental impurities.

In one embodiment, D comprises gallium. In some such embodiments, the quantity x from formula 1, above, is in the range from about 0.05 to about 1, and in particular embodiments, x is in the range from about 0.06 to about 0.07. A majority of D (molar basis) may be gallium, and in some embodiments D is gallium except for incidental impurities.

In one embodiment, D comprises aluminum. In some such embodiments, the quantity x from formula 1, above, is in the range from about 0.03 to about 0.06, and in particular embodiments, x is in the range from about 0.04 to about 0.06. A majority of D (molar basis) may be aluminum, and in some embodiments D is aluminum except for incidental impurities.

The various coatings described herein may be applied by any of several methods used to deposit coatings, including chemical vapor deposition (CVD), physical vapor deposition (PVD), and thermal spray techniques, all of which are well known in the coating arts. The thickness of the various layers is comparable to that used in other EBC systems. For instance, in some embodiments the bondcoat has a thickness ranging from about 10 micrometers up to about 250 micrometers. In certain embodiments, this thickness is in the range from about 50 micrometers to about 150 micrometers, and in particular embodiments the thickness is in the range from about 75 micrometers to about 125 micrometers. The thickness of the topcoat is comparable to that used in other EBC systems, and is generally selected to provide adequate protection for the particular environment and desired service life of the substrate being coated. In certain embodiments, the topcoat has a thickness of greater than about 25 micrometers. In particular embodiments, the thickness is in the range from about 25 micrometers to about 1000 micrometers. The thickness of the coating of the present invention, in certain embodiments, is comparable to the ranges given above for the topcoat, as is the thickness of any intermediate coatings.

The substrate may be any suitable material, such as a metallic alloy, an intermetallic material, a ceramic, or a composite material. The substrate comprises silicon in some embodiments. The substrate may comprise a silicon-bearing ceramic compound, metal alloy, intermetallic compound, or combinations of these. Examples of intermetallic compounds include, but are not limited to, niobium silicide, tungsten silicide, and molybdenum silicide. Examples of suitable ceramic compounds include, but are not limited to, silicon carbide, and silicon nitride. Embodiments of the present invention include those in which the substrate comprises a ceramic matrix composite (CMC) material. CMC's typically comprise a matrix phase and a reinforcement phase embedded in the matrix phase. The CMC may be any material of this type, including composites in which the CMC matrix phase and reinforcement phase both comprise silicon carbide. Regardless of material composition, in some embodiments the substrate comprises a component of a turbine assembly, such as, among other components, a combustor component, a shroud, a turbine blade, or a turbine vane.

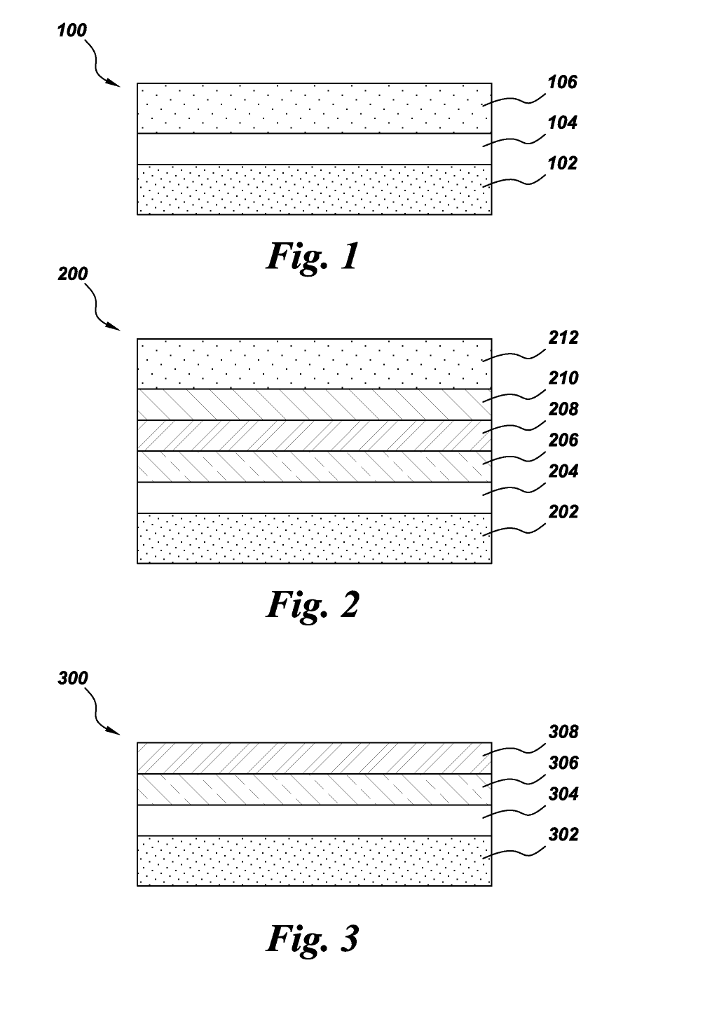

Referring to FIG. 1, an illustrative embodiment of the invention includes an article 100 comprising a substrate 102, a bondcoat 104 disposed over substrate 102, and a coating 106 disposed over bondcoat 104. Coating 106 comprises a silicate phase having a composition in accordance with the formula

(A₍₁₋ₓ₎Dₓ)₂Si₂O₇,

where x is a number at least 0.03 and up to 1. In this example, A comprises yttrium. D comprises indium, aluminum, gallium, or combinations thereof. In one embodiment, D comprises indium and x is a number at least 0.13 and up to 1. In particular embodiments, the silicate phase is yttrium indium disilicate. In another embodiment, D comprises gallium and x is a number at least 0.05 and less than 1. In particular embodiments, the silicate phase is yttrium gallium disilicate. In yet another embodiment, D comprises aluminum and x is a number at least 0.03 and up to 0.06. In particular embodiments, the silicate phase is yttrium aluminum disilicate. Substrate 102 comprises a silicon-bearing ceramic material, such as silicon carbide, and bondcoat 104 comprises silicon.

FIGS. 2 and 3 demonstrate illustrative embodiments in which the coating bearing the silicate phase described above may be used in various coating configurations. Referring to FIG. 2, one illustrative embodiment includes an article 200 comprising a substrate 202 comprising a silicon-bearing ceramic material, a bondcoat 204 comprising silicon disposed over substrate 202; a first layer 206 disposed over bondcoat 204; a second layer 208 comprising an alkaline-earth aluminosilicate (such as barium strontium aluminosilicate) disposed over first layer 206; a third layer 210 disposed over second layer 208; and a fourth layer 212, disposed over third layer 210, comprising a monosilicate (for example, yttrium monosilicate). Either or both of layers 206 and 210 comprise a silicate phase having any of the compositions described previously in accordance formula 1. In certain embodiments, one of layers 206 and 210 comprise the above silicate phase, while the other layer comprises a different type of silicate, such as (but not limited to) a rare earth silicate or yttrium silicate.

Referring to FIG. 3, another illustrative embodiment includes an article 300 comprising a substrate 302 comprising a silicon-bearing ceramic material; a bondcoat 304 comprising silicon disposed over substrate 302; a first layer 306 disposed over bondcoat 304, wherein first layer 306 comprises a silicate phase having any of the compositions described previously in accordance with formula 1; and a second layer 308 disposed over first layer 306, the second layer comprising a monosilicate (for example, yttrium monosilicate). In particular embodiments, the silicate phase is yttrium indium disilicate.

### Examples

The following examples are included to further illustrate embodiments of the invention, and should not be understood as limiting the scope of the invention.

Three pellets were made by mixing powders of indium oxide, yttrium oxide, and silicon oxide to form the following compositions:

| Sample | | Oxide Mass |
|---|---|---|
| Number | Nominal composition | Fractions [%] |
| 1 | Y₂Si₂O₇ | 65.45 Y₂O₃ + |
| | | 34.55 SiO₂ |
| 2 | (Y_{0.85}In_{0.15})₂Si₂O₇ | 54.40 Y₂O₃ + |
| | | 11.84 In₂O₃ + |
| | | 33.79 SiO₂ |
| 3 | (Y_{0.7}In_{0.3})₂Si₂O₇ | 43.80 Y₂O₃ + |
| | | 23.15 In₂O₃ + |
| | | 33.05 SiO₂ |

The oxide powders were weighed out in desired proportions and mixed by wet ball milling. The mixed powders were dried and cylindrical pellets were pressed. The pellets were reacted/homogenized at 1500 degrees Celsius for 10 hours. Pellets were evaluated for phase composition by X-ray diffraction and for coefficient of thermal expansion (CTE) by dilatometry. The diffraction measurements confirmed that Sample 1 formed substantially gamma phase while both Sample 2 and Sample 3 formed substantially beta phase, suggesting that the addition of indium indeed stabilized the lower-temperature beta phase in these samples. Furthermore, dilatometry showed that Sample 2 and Sample 3 had CTE similar to that of Sample 1 over the temperature range from 20 degrees Celsius to 1350 degrees Celsius.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An article comprising:
a substrate; and
a coating disposed over the substrate, wherein the coating comprises a silicate phase, the silicate phase having a composition in accordance with the formula
(A₍₁₋ₓ₎Dₓ)₂Si₂O₇,
where x is a number at least 0.03 and up to 1;
wherein A comprises yttrium and D comprises a Group 13 element.

2. The article of claim 1, wherein D comprises indium.

3. The article of claim 2, wherein x is at least 0.13 and up to 1.

4. The article of claim 1, wherein D comprises gallium.

5. The article of claim 4, wherein x is in a range from about 0.05 to about 1.

6. The article of claim 4, wherein x is in a range from about 0.06 to about 0.07.

7. The article of claim 1, wherein D comprises aluminum.

8. The article of claim 7, wherein x is in a range from about 0.03 to about 0.06.

9. The article of claim 7, wherein x is in a range from about 0.04 to about 0.06.

10. The article of claim 1, wherein the substrate comprises silicon.

11. The article of claim 10, wherein the substrate comprises a silicon-bearing ceramic material.

12. The article of claim 1, further comprising a bondcoat disposed between the substrate and the coating, the bondcoat comprising silicon.

13. The article of claim 1, further comprising a topcoat disposed over the coating.

14. The article of claim 13, wherein the topcoat comprises an aluminosilicate or a silicate.

15. The article of claim 1, wherein the article comprises a component of a gas turbine assembly.

16. The article of claim 15, wherein the component is a vane, a blade, a shroud, or a combustor component.

17. An article comprising:
a substrate comprising a silicon-bearing ceramic material;
a bondcoat comprising silicon disposed over the substrate; and
a coating disposed over the bondcoat, wherein the coating comprises a silicate phase, the silicate phase having a composition in accordance with the formula
(A₍₁₋ₓ₎Dₓ)₂Si₂O₇,
where x is a number at least 0.13 and less than 1;
wherein A comprises yttrium and D comprises indium.

18. An article comprising:
a substrate comprising a silicon-bearing ceramic material;
a bondcoat comprising silicon disposed over the substrate; and
a coating disposed over the bondcoat, wherein the coating comprises a silicate phase, the silicate phase having a composition in accordance with the formula
(A₍₁₋ₓ₎Dₓ)₂Si₂O₇,
where x is a number at least 0.05 and less than 1;
wherein A comprises yttrium and D comprises gallium.

19. An article comprising:
a substrate comprising a silicon-bearing ceramic material;
a bondcoat comprising silicon disposed over the substrate; and
a coating disposed over the bondcoat, wherein the coating comprises a silicate phase, the silicate phase having a composition in accordance with the formula
(A₍₁₋ₓ₎Dₓ)₂Si₂O₇,
where x is a number at least 0.03 and up to 0.06;
wherein A comprises yttrium and D comprises aluminum.
